(19) United States
(12) Patent Application Publication
(10) Pub. No.: US 2011/0145231 A1
(43) Pub. Date: Jun. 16, 2011

(54) METHOD AND A SYSTEM FOR RANKING OF EMPLOYMENT CANDIDATES ACCORDING TO EXTERNAL DATABASES

(75) Inventor: Nimrod Ronen, Giva'ataim (IL)

(73) Assignee: Niloos Software Ltd, Tel-Aviv (IL)

(21) Appl. No.: 12/883,202

(22) Filed: Sep. 16, 2010

Related U.S. Application Data
(60) Provisional application No. 61/285,214, filed on Dec. 10, 2009.

(51) Int. Cl. G06F 17/30

(52) U.S. Cl. 707/728; 707/E17.014

(57) ABSTRACT

A method for automatically calculating a job applicant's relevance rating. The method includes retrieving the new applicant's data from data previously stored on an applicants' search engine database and retrieving obsolescence curve data from an obsolescence curve database containing graphic information. The method also includes calculating a new applicant's relevance or recalculating the relevance of an already stored applicant from said obsolescence curve data. Finally, the method further includes changing the rating for an already stored applicant according to the new value and saving the new rating to the applicants' search engine database, wherein relevance refers to the probability that the applicant is looking for a job.

### FIELD OF THE INVENTION

The present invention relates generally to hiring employees, and more particularly to a method and a system for employment candidate ranking according to external databases.

### BACKGROUND OF THE INVENTION

Evaluating employment candidates is both art and science. Gathering information to hire the right person is based on the art of evaluating resumes, education, appearance, work history and using state of the art psychometric assessments which evaluate the total person as related to job fit.

Employment candidates are selective. They reveal only what they want to be seen, while an interviewer may think himself to be in control of the situation. The information provided may be only 10% of the total person. This good, but limited information includes the following:
1. Resume—according to organizations such as the Society for Human Resource Management and other reputable associations, between 25% and 40% of candidates use creative writing to expand education credentials, work expertise, omit places of employment etc. In this case it is caveat emptor—“buyer beware.”
2. Education—always trust but verify: and did they “attend,” pursue or graduate? Make certain there are dates, places, and grade point averages.
3. Appearance—candidates look their best on the day of the interview.
4.Work History—a hoped for accurate summary of employment, skills, and work related accomplishments

Even with skilled, professional, behavioral interviewing, the majority of the candidate is hidden from view. So what is missing?
1. Thinking and Reasoning Skills—The skill to utilize verbal and mathematical skills reasoning and problem solving components. These are key indicators of success.
2. Occupational interests—What are the candidates interests—and how do they compare with the interests needed for success in the position?
3. Behavioral traits—Components compared with those required for success in the position including: assertiveness, sociability, manageability, attitude, decisiveness, accommodating, independence, and objective judgment.

There are a variety of pre employment assessment tools on the market. Using the Department of Labor criteria, one must make sure the instrument has been thoroughly researched for validity, reliability and is “job related.” Profile XT is an exemplary prior art tool for evaluating candidates.

Methods and tools for job searching and placement services are known in the art. Such methods and tools are offered, for example, on well known Internet Web sites including www.Monster.com, www.Linkedln.com, www.HotJobs.com, and www.RealContacts.com.

### SUMMARY OF THE INVENTION

Accordingly, it is a principal object of the present invention to provide a method and a system for employment candidate ranking according to information derived from external bases.

It is a further principal object of the present invention to provide an improved unique solution for human resources departments in order to handle the CV's they receive.

It is another principal object of the present invention to provide software that can perform automatic filtering of the candidates and route them to recruiting managers, while keeping track of the candidates and receiving automatic feedback during the recruitment process.

It is a one other principal object of the present invention to provide automatic receiving, analysis and filing of CVs and resumes.

It is a yet one other principal object of the present invention to provide automated searching, filtering and sorting of resumes.

It is yet one other principal object of the present invention to provide software that can be integrated into ERP and CRM systems such as SAP, Oracle ERP, Microsoft CRM and others.

A method is described for automatically calculating a job applicant's relevance rating. Every candidate sending a CV which is processed, analyzed and rated according the information found in his resume and external as well as internal databases, such as those rating workplaces and educational institutions. The method includes retrieving the new applicant's data from data previously stored on an applicants' search engine database and retrieving obsolescence curve data from an obsolescence curve database containing graphic information.

The method also includes calculating a new applicant's relevance or recalculating the relevance of an already stored applicant from said obsolescence curve data. Finally, the method further includes changing the rating for an already stored applicant according to the new value and saving the new rating to the applicants' search engine database, wherein relevance refers to the probability that the applicant is looking for a job.

The applicant's data for automatically rating employment candidates includes the ratings according to a work place related database and according to perseverance of candidates in each workplace.

The applicant's data for automatically rating employment candidates also includes the ratings of information about their social connections, networks and general information that is found on the Internet and the cross-checking of this information with a database of similar information.

CV's which are received into a recruiter's inbox, for example, undergo the process of automated analysis and filing without regard to the format of the CV. Due to this analysis a recruiter may later search for important data in the CV's such as: experience, education, personal info and even the notes written in the CV.

The “Automatic Hunter” scans the existing or incoming CV's and searches for specified criteria. The “Automatic Hunter” feature of the software constantly continues its tasks and sends email messages when CV's meeting requirement criteria enter the system.

The present invention provides supervision of candidates in the recruitment process. After locating candidates meeting a recruiter's criteria, the interview summaries are passed and the progress of the candidate is supervised under the recruiting manager. The software will send notes about the candidate and a special engine manages the recruitment process, thereby enabling the recruiter and the recruiting manager to move the candidate through various stages of the recruitment process.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

For a better understanding of the invention with regard to the embodiments thereof, reference is now made to the accompanying drawings, in which like numerals designate corresponding elements or sections throughout, and in which:

FIG. 1 is a schematic flow diagram illustrating the system for automated comprehensive resume processing, constructed in accordance with the principles of a preferred embodiment of the present invention;

FIG. 2 is a schematic illustration of a screenshot of the “dashboard” for a human resources management system, constructed in accordance with the principles of a preferred embodiment of the present invention;

FIG. 3 is schematic illustration of a screenshot of the employer search results for a human resources management system, constructed in accordance with the principles of a preferred embodiment of the present invention;

FIG. 4 is schematic illustration of a screenshot of details of a selected employer for a human resources management system, constructed in accordance with the principles of a preferred embodiment of the present invention;

FIG. 5 is schematic illustration of a screenshot of details of a selected applicant for a human resources management system, constructed in accordance with the principles of a preferred embodiment of the present invention;

FIG. 6 is schematic illustration of a screenshot of the applicant search results for a human resources management system, constructed in accordance with the principles of a preferred embodiment of the present invention; and

FIG. 7 is schematic illustration of a screenshot of a template for applicant search for a human resources management system, constructed in accordance with the principles of a preferred embodiment of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

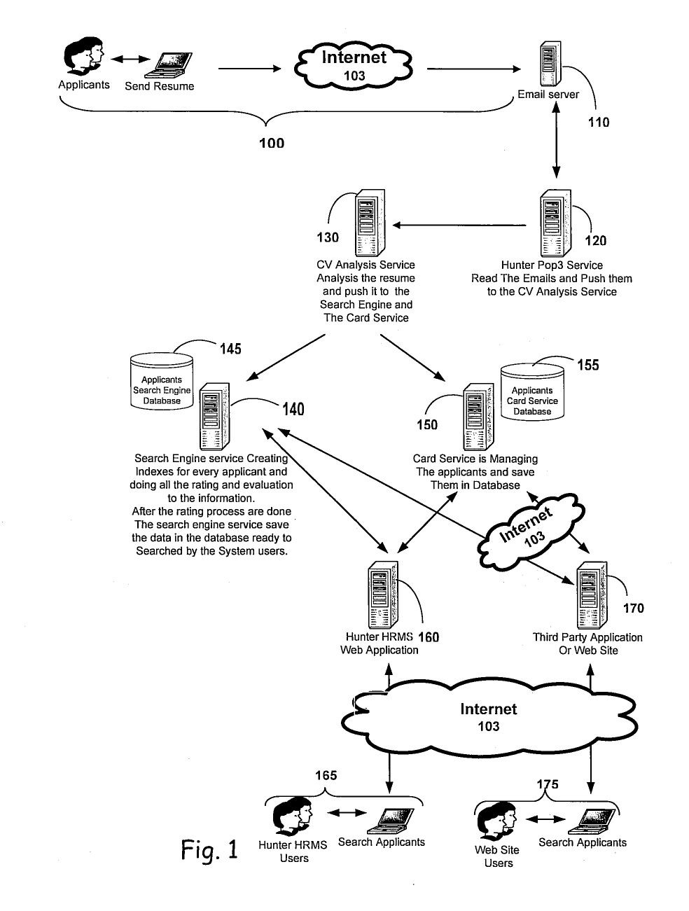

FIG. 1 is a schematic flow diagram illustrating the system for automated comprehensive resume processing, constructed in accordance with the principles of a preferred embodiment of the present invention. Applicants submit resumes 100 via the Internet 103, for example. The resumes are received by an email server 110. The Hunter Pop3 Service module 120 reads the emails and forwards them to the CV Analysis Service module 130. CV Analysis Service module 130 analyzes each of the received resumes and forwards them to the Search Engine Service module140 as well as to the Card Service module 150.

Search Engine Service module 140 creates indices for every applicant and does all the rating and evaluation of the information. After completing the rating process Search Engine Service module 140 saves the data in the Applicants Search Engine Database 145. The data is then available to be searched by the recruiting users of the system. Card Service module 150 manages the applicant information and saves the information in the Applicants Card service Database 155.

Hunter Human Resources Management Services (HRMS) users 165 access Search Engine Service module 140 and Card Service module 150 with their respective databases 145, 155 via the Hunter HRMS Web Application 160. Similarly, private Web site users 175 also access Search Engine Service module 140 and Card Service module 150 with their respective databases 145, 155 via the Third Party Web Application or Web site 170.

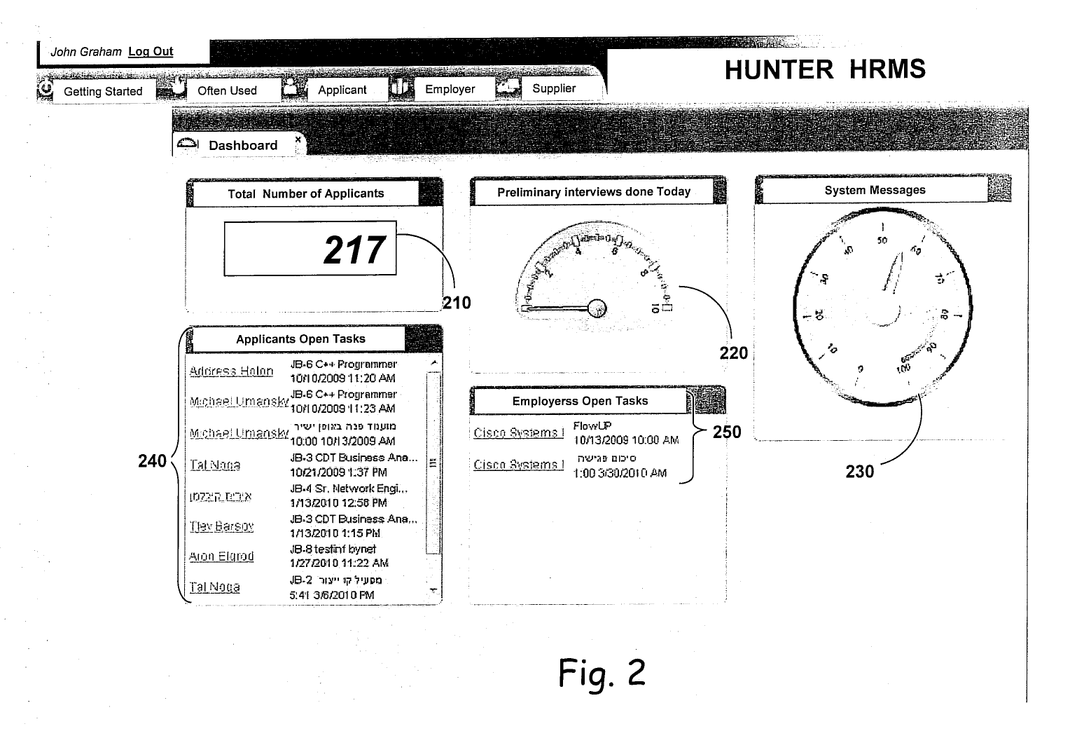

FIG. 2 is a schematic illustration of a screenshot of the “dashboard” for a human resources management system, constructed in accordance with the principles of a preferred embodiment of the present invention. The total number of applicants 210, the number of preliminary interviews done today 220 and the number of system messages 230 are shown. The applicants open tasks 240 and employers open tasks 250 are listed.

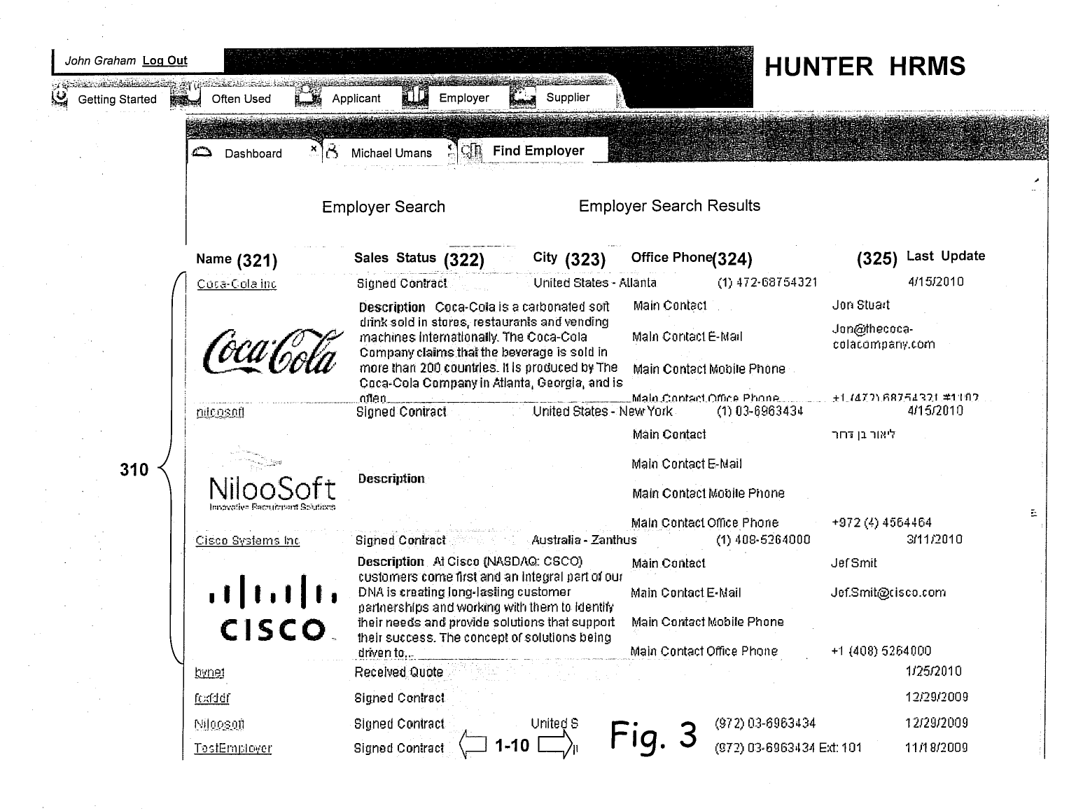

FIG. 3 is schematic illustration of a screenshot of the employer search results for a human resources management system, constructed in accordance with the principles of a preferred embodiment of the present invention. The results 310 of an employer search, based on various search criteria are shown. The name and logo 321; sales status 322, e.g. a signed contract; city 323; contact information 324; and last update information 325 are shown.

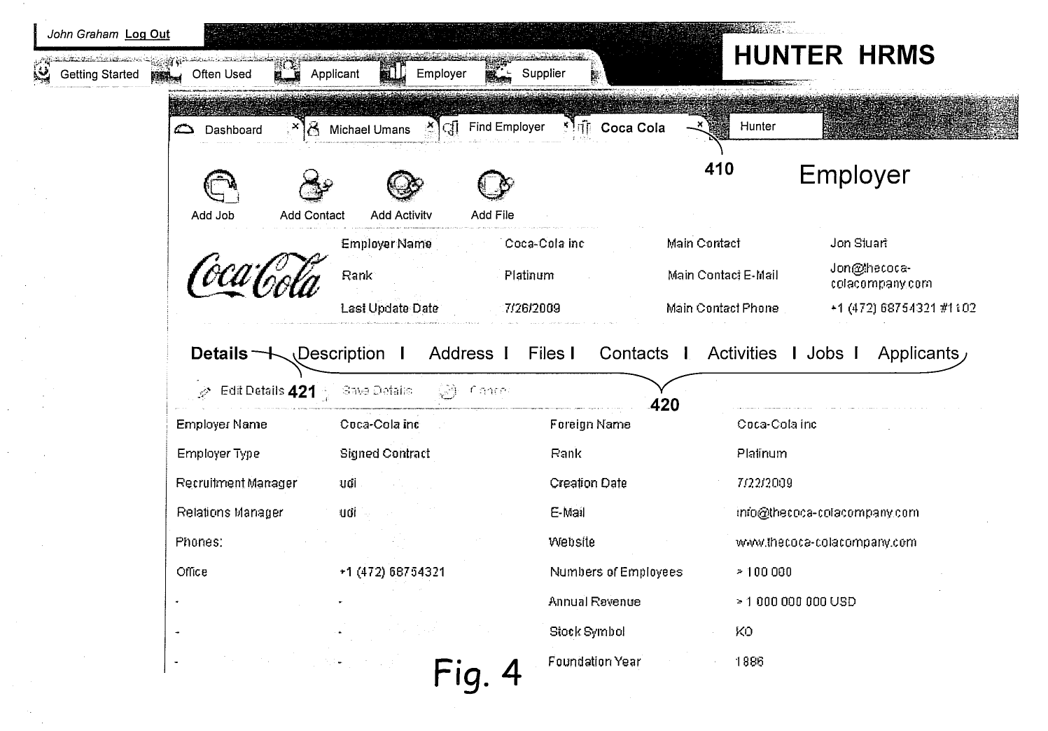

FIG. 4 is schematic illustration of a screenshot of details of a selected employer for a human resources management system, constructed in accordance with the principles of a preferred embodiment of the present invention. The particular tab for the employer Coca Cola is shown selected 410. Details 421 has been selected on the features bar 420.

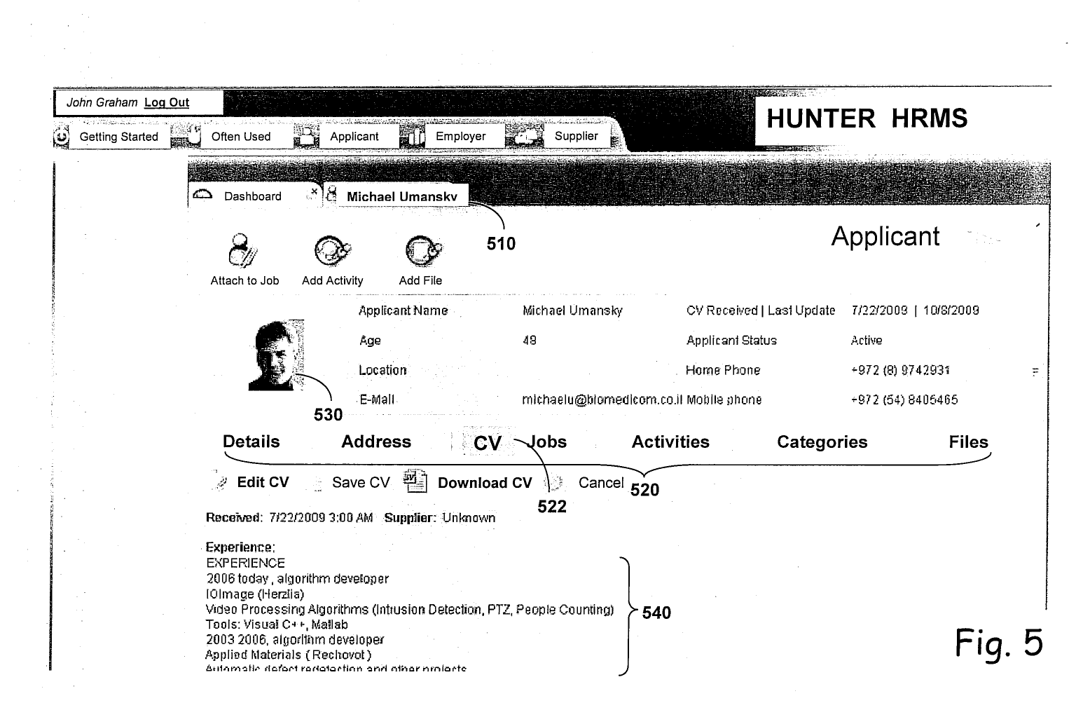

FIG. 5 is schematic illustration of a screenshot of details of a selected applicant for a human resources management system, constructed in accordance with the principles of a preferred embodiment of the present invention. The particular tab for the applicant, Michael Umansky, is shown selected 510. CV 522 has been selected on the features bar 520. The applicant's photo 530 and a portion of his experience 540 are shown.

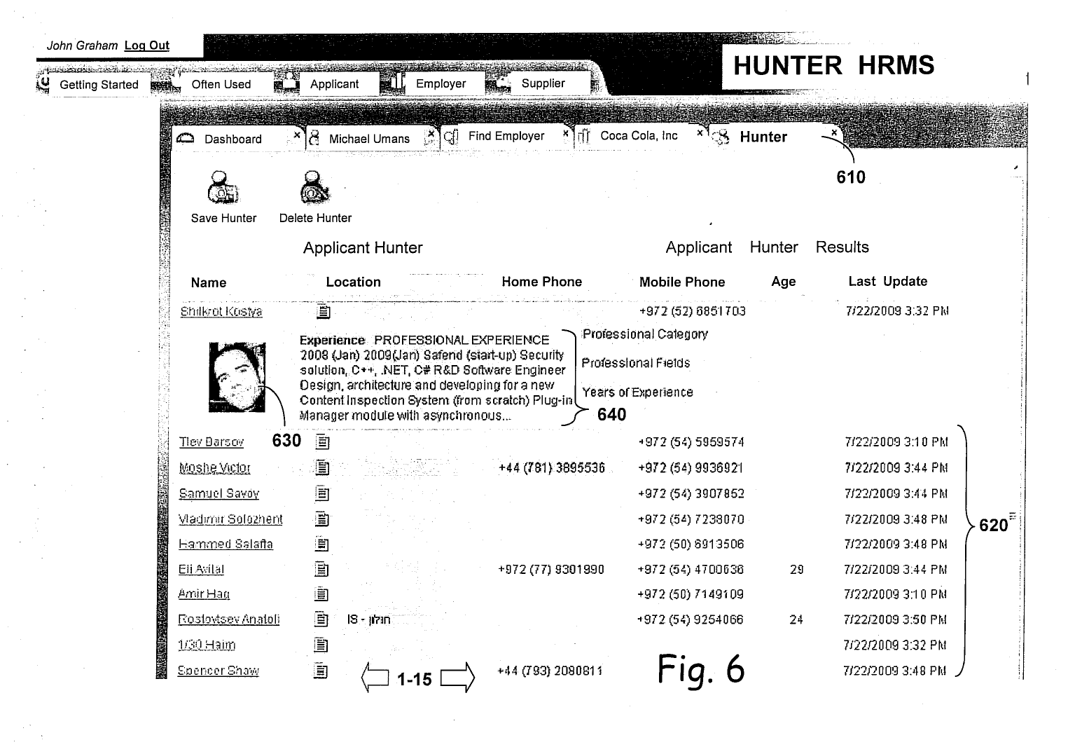

FIG. 6 is schematic illustration of a screenshot of the applicant search results for a human resources management system, constructed in accordance with the principles of a preferred embodiment of the present invention. The particular tab for the applicant “hunter” search is shown selected 610. A list of relevant applicants and a portion of their contact information is shown 620. The selected applicant's photo 630 and a portion of his experience 640 are shown.

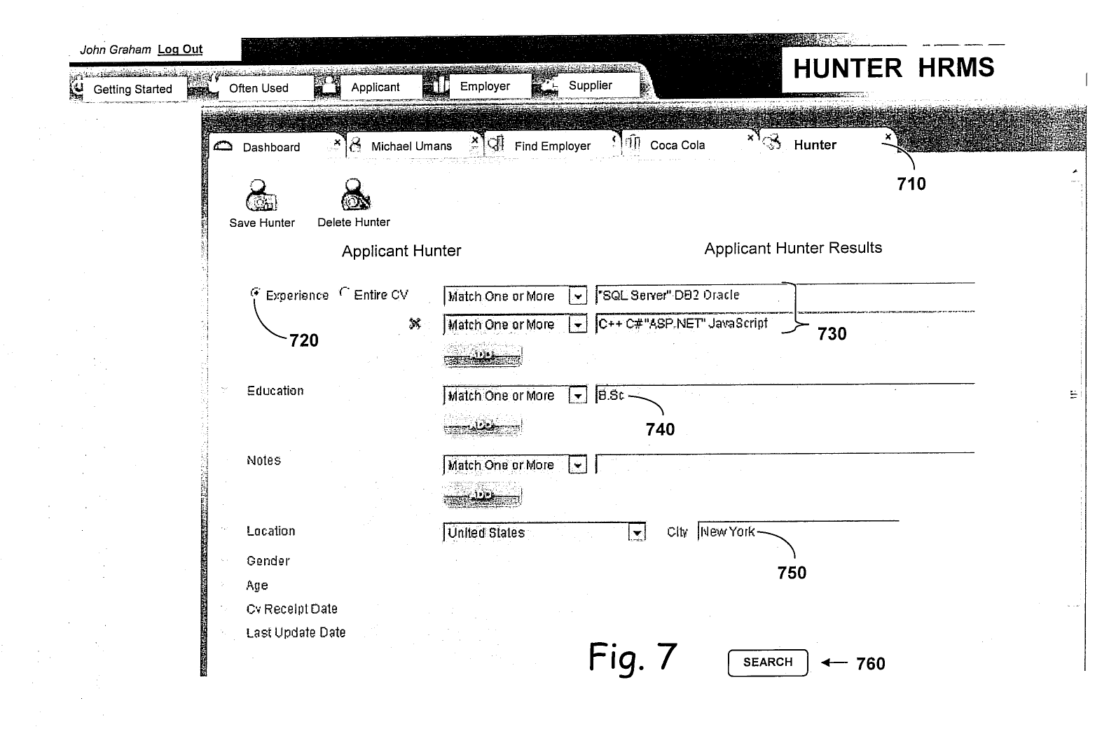

FIG. 7 is schematic illustration of a screenshot of a template for applicant search for a human resources management system, constructed in accordance with the principles of a preferred embodiment of the present invention. Again, as described with reference to FIG. 6 above, the particular tab for the applicant “hunter” search is shown selected 710. The experience portion 720 of the CV has been selected, along with two (2) desired specific areas of experience 730. Specific education 740 and location 750 requirements have been entered appropriately. At this point the “Hunter” would click the search button 760.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. A method for automatically calculating a job applicant's relevance rating, said method comprising:
retrieving the new applicant's data from data previously stored on an applicants' search engine database;
retrieving obsolescence curve data from an obsolescence curve database containing graphic information;
calculating a new applicant's relevance or recalculating the relevance of an already stored applicant from said obsolescence curve data; and
changing the rating for an already stored applicant according to the new value and saving the new rating to the applicants' search engine database,
wherein relevance refers to the probability that the applicant is looking for a job.

2. The method of claim 1, wherein said applicant's data for automatically rating employment candidates comprises at least the ratings of their universities and degree.

3. The method of claim 1, wherein said applicant's data for automatically rating employment candidates comprises at least the ratings according to a work place related database and according to perseverance of candidates in each workplace.

4. The method of claim 1, wherein said applicant's data for automatically rating employment candidates comprises at least the ratings of information about their social connections, networks and general information that is found on the Internet and cross-checking said information with a database of similar information.
